(19) United States
(12) Patent Application Publication
(10) Pub. No.: US 2025/0155578 A1
(43) Pub. Date: May 15, 2025

(54) 3-D OBJECT DETECTION BASED ON SYNTHETIC POINT CLOUD FRAMES

(71) Applicant: Waymo LLC, Mountain View, CA (US)

(72) Inventors: Yingwei Li, Middle River, MD (US); Ruizhongtai Qi, Mountain View, CA (US); Yin Zhou, San Jose, CA (US); Chenxi Liu, Santa Clara, CA (US); Dragomir Anguelov, San Francisco, CA (US)

(21) Appl. No.: 18/506,925

(22) Filed: Nov. 10, 2023

(51) Int. Cl. G01S 17/931

(52) U.S. Cl. CPC G01S 17/931

(57) ABSTRACT

Methods, systems, and apparatus, including computer programs encoded on a computer storage medium, for processing point cloud data to generate an output. In one aspect, a method includes obtaining a sequence of multiple point cloud frames, wherein the sequence of multiple point cloud frames comprise a target point cloud frame and a plurality of other point cloud frames; processing one or more other point cloud frames to generate one or more respective predicted locations at the target timestamp for each of one or more objects detected in the one or more other point cloud frames; generating, based on the respective predicted locations at the target timestamp for each of one or more objects, a synthetic point cloud frame that is associated with the target timestamp; and processing at least the synthetic point cloud frame to generate one or more outputs that characterize an environment at the target timestamp.

### BACKGROUND

This specification relates to autonomous vehicles.

Autonomous vehicles include self-driving cars, boats, and aircraft. Autonomous vehicles use a variety of on-board sensors and computer systems to detect nearby objects and use such detections to make control and navigation decisions.

Some autonomous vehicles have computer systems that process sensor data, e.g., laser sensor data, using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### BRIEF DESCRIPTION OF THE DRAWINGS

FIG. 1 is a block diagram of an example on-board system.

FIG. 2 is an example illustration of operations performed by an object detection subsystem.

FIG. 3 is a flow diagram of an example process for generating one or more outputs that characterize an environment.

FIG. 4 is a flow diagram of sub-steps of one of the steps of the process of FIG. 3.

Like reference numbers and designations in the various drawings indicate like elements.

### DETAILED DESCRIPTION

This specification describes a system implemented as computer programs on one or more computers in one or more locations that obtains a temporal sequence of point cloud frames generated from sensor readings of an environment collected by one or more sensors. The system processes the temporal sequence of point cloud frames to generate an output that characterizes the environment.

Each point cloud frame in the temporal sequence includes multiple data points that represent a sensor measurement of a scene in the environment captured by the one or more sensors.

Each data point in a point cloud frame is represented by multiple attributes, including position, and, sometimes additional features such as intensity, color information, second return, or normals.

For example, the one or more sensors can be laser sensors, e.g., LiDAR sensors or other sensors that are considered to detect reflections of laser light, of an autonomous vehicle, e.g., a land, air, or sea vehicle, and the scene can be a scene that is in the vicinity of the autonomous vehicle.

The sequence is referred to as a “temporal” sequence because the point cloud frames are arranged according to the order in which the corresponding sensor measurements were generated, with point cloud frames corresponding to sensor measurements that were generated earlier in time being earlier in the sequence than point cloud frames corresponding to sensor measurements that were generated later in time. For example, the temporal sequence of point cloud frames can be generated as a vehicle having one or more laser sensors navigates through a real-world environment.

Some systems use machine learning algorithms to recognize and detect objects in point cloud data. While object recognition and detection by using machine learning algorithms to process point cloud data may be reliable when objects are located at distances of no more than a predetermined range, e.g., 100 meters, 80 meters, 50 meters, or less, from the one or more sensors that generate the point cloud data, accurately recognizing and detecting objects located beyond this range using point cloud data might be challenging. Moreover, some objects might be occluded by other objects; for certain types of objects, e.g., large vehicles such as class 8 trucks (e.g., trucks, tractor-trailer units, recreational vehicles, buses, or tall work vans), the objects may be more likely to become occluded by other objects (e.g., other vehicles). An occluded object is an object that is (in part or in whole) not in the direct line of sight of the one or more sensors.

There are many instances where detection of objects beyond the predetermined range, objects that are occluded, or both is important. For example, when an autonomous vehicle is driving on a highway at 65 miles per hour, an object detected at 100 meters would be passed by in under 4 seconds. This gives very little time for the autonomous vehicle to change lanes, an action which may be necessary in certain jurisdictions which require that vehicles change lanes to move away from a vehicle stopped on a shoulder area, etc. In this example, an approach that detects and tracks objects at longer ranges or object that are occluded by processing point cloud data using conventional techniques may not be able to generate timely and accurate prediction data that facilitates the generation of such an action.

Generally, the closer an object is relative to a laser sensor, the denser the point cloud (i.e., the greater the number of data points in a point cloud frame that belong to the object); on the contrary, the farther away an object is relative to a laser sensor, or analogously, the more occluded an object is in the field of view of a laser sensor, the sparser the point cloud (i.e., the fewer the number of data points in a point cloud frame that belong to the object).

When there are very few data points in a point cloud frame that belong to an object, making accurate predictions about the object by processing the point cloud data using conventional techniques can be difficult. For example, it can be difficult to accurately detect or recognize the object and even more difficult to make more fine-grained predictions that characterize one or more additional aspects of the object, e.g., estimated object size and estimated heading of the object.

Some techniques described in this specification allow an object detection system to process a temporal sequence of point cloud frames to generate one or more outputs that characterize various objects in the point clouds at a higher accuracy, e.g., higher object detection accuracy, than existing systems by generating a set of synthetic data points from the temporal sequence of point cloud frames and then processing an input that includes the set of synthetic points by using the object detection system. The set of synthetic data points propagate object information from the other point cloud frames included in the temporal sequence to a synthetic frame to boost the performance of the object detection system while not adding much computation overhead.

For example, objects (e.g., vehicles or pedestrians) can be accurately detected by the object detection system even when they are located at a far distance, occluded, or both. In this example, because planning decisions that account for such objects (which may otherwise be neglected or misclassified by existing systems) can be made in accordance with the more accurate object detection outputs, the described techniques thus further enable an on-board system of an autonomous vehicle to control the vehicle to travel along a safer trajectory.

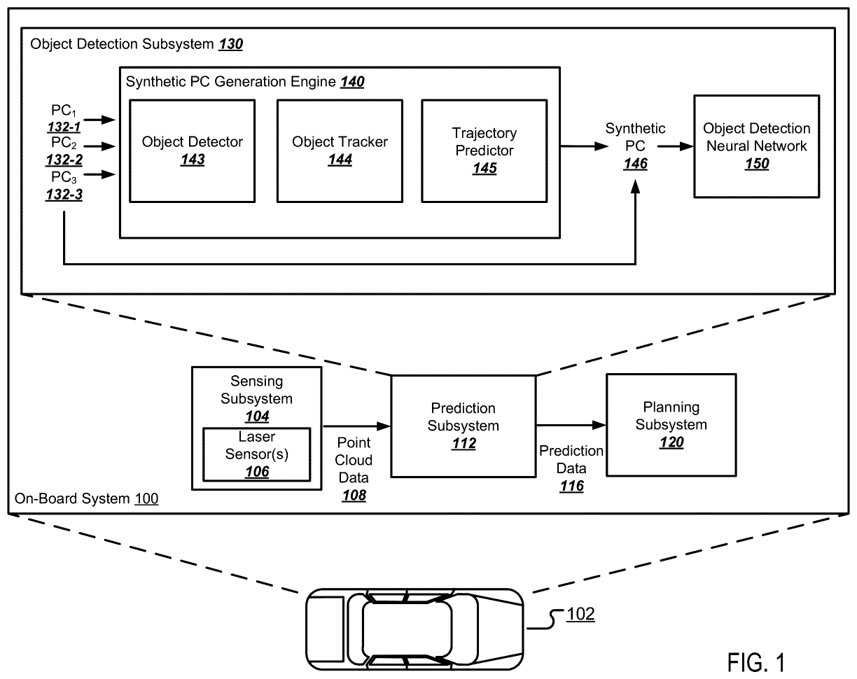

FIG. 1 is a block diagram of an example on-board system 100. The on-board system 100 is physically located on-board a vehicle 102. Being on-board the vehicle 102 means that the on-board system 100 includes components that travel along with the vehicle 102, e.g., power supplies, computing hardware, and sensors. In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle. As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 102 can alert the driver of the vehicle 102 or take an autonomous driving action when an obstacle is detected, when the vehicle departs from a driving lane, or when an object is detected in a blind spot of the human driver. In another example, in response to determining that another agent might interact with the vehicle 102, the vehicle 102 can alert the driver or autonomously apply the brakes of the vehicle 102 or otherwise autonomously change the trajectory of the vehicle 102 to prevent an unwanted interaction between the vehicle 102 and an agent.

Although the vehicle 102 in FIG. 1 is depicted as an automobile, and the examples in this specification are described with reference to automobiles, in general the vehicle 102 can be any kind of vehicle. For example, besides an automobile, the vehicle 102 can be another kind of autonomous vehicle that travels along a roadway, e.g., a truck or a motorcycle. Moreover, the on-board system 100 can include components additional to those depicted in FIG. 1 (e.g., a collision detection system or a navigation system).

To enable the safe control of the autonomous vehicle 102, the on-board system 100 includes a sensor subsystem 104 which enables the on-board system 100 to “see” the environment in the vicinity of the vehicle 102. For example, the environment can be an environment in the vicinity of the vehicle 102 as it drives along a roadway. The term “vicinity,” as used in this specification, refers to the area of the environment that is within the sensing range of one or more of the sensors of the vehicle 102. The agents in the vicinity of the vehicle 102 may be, for example, pedestrians, bicyclists, or other vehicles.

The sensor subsystem 104 includes, amongst other types of sensors, one or more laser sensors 106 that are configured to detect reflections of laser light from the environment in the vicinity of the vehicle 102. Examples of a laser sensor 106 include a time-of-flight sensor, a stereo vision sensor, a two-dimensional light detection and ranging (LiDAR) sensor, a three-dimensional LiDAR sensor, and so on.

The sensor subsystem 104 continually (i.e., at each of multiple time points within a given time period) captures raw sensor measurements which can indicate the directions, intensities, and distances travelled by reflected radiation. For example, a laser sensor 106 can transmit one or more pulses of electromagnetic radiation in a particular direction and can measure the intensity of any reflections as well as the time that the reflection was received. A distance can be computed by determining the time which elapses between transmitting a pulse and receiving its reflection. Each laser sensor can continually sweep a particular space in angle, azimuth, or both. Sweeping in angle, for example, can allow the laser sensor to detect multiple objects in an area within the field of view of the laser sensor.

The sensor subsystem 104, or another subsystem such as a data representation subsystem also on-board the vehicle 102, uses the raw sensor measurements (and, optionally, additional data available in data repositories stored within the autonomous vehicle 102, or data repositories outside of, but coupled to, the autonomous vehicle, such as in a data center with the data available made to the autonomous vehicle over a cellular or other wireless network) to generate sensor data that that characterizes the agents and environment in the vicinity of the vehicle 102.

The sensor data includes point cloud data 108. The point cloud data 108 can be generated in any of a variety of ways. In some implementations, the raw laser sensor measurements (e.g., raw LiDAR sensor measurements) can be complied into a point cloud frame, e.g., a three-dimensional point cloud frame (e.g., a LiDAR point cloud frame), that includes a collection of laser sensor data points, with each laser sensor data point having a position, and, optionally, other features such as intensity, color information, second return, or normals. The position can, for example, be represented as either a range and elevation pair, or 3D coordinates (x, y, z), in a coordinate system that is centered around a given location, e.g., the position on which the one or more laser sensors are located on the autonomous vehicle 102.

Since the raw sensor measurements are continually captured, the point cloud data 108 can be provided as a data stream that includes a temporal sequence of point cloud frames. The temporal sequence of point clouds includes multiple point cloud frames. Each point cloud frame is associated with a timestamp which identifies a specific time window. The timestamp can, for example, define a beginning or an end of the specific time window or the midpoint of the specific time window. The length of each time window can, for example, depend on the time required by a laser sensor to perform a full sweep or revolution within its field of view.

Each point cloud frame includes a collection of laser sensor data points that are generated based on raw laser sensor measurements captured during the specific time window identified by the associated timestamp. For example, each point cloud frame can include a collection of laser sensor data points that represent reflections of pulses of laser light transmitted by a laser sensor during the specific time window identified by the associated timestamp.

The sequence is referred to as a temporal sequence because the point cloud frames are arranged according to the order in which the corresponding sensor measurements were captured during the given time period, e.g., such that the most recent point cloud frame is the last frame in the sequence, while the least recent point cloud frame is the first frame in the sequence. For example, the point cloud data 108 can include a first point cloud frame associated with a first timestamp, a second point cloud frame associated with a second timestamp that is after the first timestamp, and so on, where the first point cloud frame is arranged preceding to the second point cloud frame in the sequence.

The on-board system 100 can provide the sensor data including the point cloud data 108 to a prediction subsystem 112 of the on-board system 100. The on-board system 100 uses the prediction subsystem 112 to, during operation of the vehicle 102, repeatedly generate prediction data 116 which predicts certain aspects of some or all of the agents in the vicinity of the vehicle 102. In addition, the on-board system 100 can send the sensor data to one or more data repositories within the vehicle 102, or data repositories outside of the vehicle 102, such as in a data center, over a cellular or other wireless network, where the sensor data is logged.

For example, the prediction data 116 can be or include object detection prediction data that specifies one or more regions in an environment characterized by the point cloud data 108 that are each predicted to depict a respective object. For example, the prediction data 116 can be or include object detection prediction data which defines a plurality of 3-D bounding boxes with reference to the environment characterized by the point cloud data 108 and, for each of the plurality of 3-D bounding boxes, a respective likelihood that an object belonging to an object category from a set of possible object categories is present in the region of the environment circumscribed by the 3-D bounding box. For example, object categories can represent animals, pedestrians, cyclists, or other vehicles within a proximity to the vehicle.

As another example, the prediction data 116 can be or include object classification prediction data which includes scores for each of a set of object categories, with each score representing an estimated likelihood that the point cloud data 108 contains data points corresponding to an object belonging to the category. For example, the prediction data 116 can specify that the point cloud data 108 likely includes data points corresponding to a nearby car.

As another example, the prediction data 116 can be or include trajectory prediction data that specifies, for each of one or more objects detected in the point cloud data 108, a predicted future trajectory of the object.

As another example, the prediction data 116 can be or include motion state prediction data that classifies each of one or more objects detected in the point cloud data 108 into a respective motion state, e.g., a dynamic state or a stationary state.

As yet another example, the prediction data 116 can be or include point cloud segmentation prediction data which defines, for each data point included in the point cloud data 108, which of multiple object categories the point belongs to.

The on-board system 100 can provide the prediction data 116 generated by the prediction subsystem 112 to a planning subsystem 120.

When the planning subsystem 120 receives the prediction data 116, the planning subsystem 120 can use the prediction data 116 to generate planning decisions which plan the future motion of the vehicle 102. The planning decisions generated by the planning subsystem 120 can include, for example: yielding (e.g., to pedestrians), stopping (e.g., at a “Stop” sign), passing other vehicles, adjusting vehicle lane position to accommodate a bicyclist, slowing down in a school or construction zone, merging (e.g., onto a highway), and parking. In a particular example, the on-board system 100 may provide the planning subsystem 116 with trajectory prediction data indicating that the future trajectory of another vehicle is likely to cross the future trajectory of the vehicle 102, potentially resulting in a collision. In this example, the planning subsystem 120 can generate a planning decision to apply the brakes of the vehicle 102 to avoid a collision.

The planning decisions generated by the planning subsystem 120 can be provided to a control subsystem of the vehicle 102. The control subsystem of the vehicle can control some or all of the operations of the vehicle by implementing the planning decisions generated by the planning subsystem. For example, in response to receiving a planning decision to apply the brakes of the vehicle, the control subsystem of the vehicle 102 may transmit an electronic signal to a braking control unit of the vehicle. In response to receiving the electronic signal, the braking control unit can mechanically apply the brakes of the vehicle.

In addition or alternatively, the on-board system 100 can provide the prediction data 116 generated by the prediction subsystem 112 to a user interface subsystem. When the user interface subsystem receives the prediction data 116, the user interface subsystem can use the prediction data 116 to present information to the driver of the vehicle 102 to assist the driver in operating the vehicle 102 safely. The user interface subsystem can present information to the driver of the vehicle 102 by any appropriate means, for example, by an audio message transmitted through a speaker system of the vehicle 102 or by alerts displayed on a visual display system in the vehicle (e.g., an LCD display on the dashboard of the vehicle 102).

To generate the various prediction data 116 from the sensor data, the prediction subsystem 112 implements trained neural networks that are each configured to process inputs derived from the sensor data in accordance with trained parameters of the neural network to generate respective outputs that are included in the prediction data 116. A neural network is said to be “trained” if the parameter values of the neural network have been adjusted, i.e., by applying a training procedure to a training set of inputs, to improve the performance of the neural network on its prediction task. In other words, a trained neural network generates an output based solely on being trained on training data rather than on human-programmed decisions. For convenience, the neural networks as used in throughout this description will generally refer to trained ones.

As illustrated in FIG. 1, to improve the accuracy when processing the point cloud data 108 to generate object detection prediction data, the prediction subsystem 112 implements an object detection subsystem 130. The object detection subsystem 130 is capable of generating object detection prediction data that includes 3-D bounding box data that identifies any of a variety of objects (e.g., animals, pedestrians, cyclists, or other vehicles) even when they are located at a far distance away from the vehicle 102 (e.g., more than a predetermined range, e.g., 50 meters, 80 meter, 100 meters, or more, ahead of the vehicle 102), occluded by another object (e.g., another vehicle in front of the vehicle 102), or both.

The object detection subsystem 130 receives as input the temporal sequence of point cloud frames included in the point cloud data 108 that are associated with different timestamps, and generates as output a synthetic point cloud frame, e.g., synthetic point cloud frame 146.

FIG. 1 thus illustrates that the object detection subsystem 130 receives a first point cloud frame 132-1 associated with a first timestamp t₁, a second point cloud frame 132-2 associated with a second timestamp t₂, and a third point cloud frame 132-3 associated with a third timestamp t₃.

The synthetic point cloud frame is associated with a target timestamp t_{target} and includes a plurality of synthetic data points that are generated by a synthetic point cloud generation engine 140 of the subsystem 130 from the input.

The target timestamp t_{target} can be any timestamp that is before, at, or after a timestamp at which a most recent point cloud frame is received by the object detection subsystem 130. For example, the subsystem 130 can receive, e.g., from a user or different software module in the prediction subsystem 112 or in the planning subsystem 120, an input that specifies which timestamp should be used as the target timestamp t_{target}. As another example, the subsystem 130 can use a future (or past) timestamp that is a fixed number of timestamps after (or before) a timestamp at which the most recent point cloud frame is received as the target timestamp t_{target}.

In this specification, a data point may be referred to as “real” when it is generated from the raw laser sensor measurements captured by one or more laser sensors. Alternatively, a data point may be referred to as “synthetic” when it is generated by the synthetic point cloud generation engine 140.

Like the laser sensor data points, the synthetic data points can each have a position, e.g., in the same coordinate system as the laser sensor data points. Unlike the laser sensor data points, however, the synthetic data points can optionally have a different set of features. For example, rather than having intensity, color information, second return, or normals as the laser sensor data points do, each synthetic data point can have various features that characterize one or more aspects of an object represented by the synthetic data point.

Generating synthetic data points will be described further below, but in short, each synthetic data point is a prediction of a real laser sensor data point and provides additional (e.g., supplementary) information about one or more objects in the environment that is missing or otherwise unavailable in the point cloud data 108, e.g., due to the long range or occlusion of the objects, that has been generated from the raw laser sensor measurements captured by one or more laser sensors, e.g., the one or more laser sensors 106 of vehicle 102.

To generate the plurality of synthetic data points, the synthetic point cloud generation engine 140 includes an object detector 143, an object tracker 144, and a trajectory predictor 145. The object detector 143 can generally be a point cloud-based object detector that processes one or more point cloud frames in the temporal sequence to generate information that detects, e.g., identifies and locates, one or more objects in each of the one or more point cloud frames.

For example, the object detector 143 can process the first point cloud frame 132-1 associated with the first timestamp t₁ to detect one or more objects that are depicted in the first point cloud frame 132-1, process the second point cloud frame 132-2 associated with the second timestamp t₂ to one or more objects that are depicted in the second point cloud frame 132-2, process the third point cloud frame 132-3 associated with the third timestamp t₃ to detect one or more objects that are depicted in the third point cloud frame 132-3, and so on.

The object detector 143 can be configured as a machine learning model, e.g., a neural network, a regression model, or as a computer vision model, e.g., a histogram of oriented gradients (HOG) model, or the like, that can process an input that includes a point cloud frame to generate an output that identifies and locates one or more objects in the point cloud frame.

The output identifying and locating an object in a given point cloud frame can be generated in any appropriate way. For example, the object detector 143 can generate, as output, bounding box data identifying one or more bounding boxes. Each bounding box represents a three-dimensional region in a given point cloud frame within which an object is detected with greater than a threshold probability. The three-dimensional region may contain any number of points therewithin. As another example, the object detector 143 can generate, as output, point-level segmentation data. Rather than using a box to define a 3-D region inside of which are points that depict an object, the point-level segmentation data identifies points of a given point cloud frame as depicting an object, or not depicting an object. Other ways of generating a model output identifying and locating an object in a given point cloud frame are possible.

The object tracker 144 tracks the one or more detected objects across the temporal sequence of point cloud frames included in the point cloud data 108 to generate, as output, a past trajectory of each of the detected objects. For a given detected object, the past trajectory of the given detected object spans a time period which ends before or at the timestamp at which the most recent point cloud frame is received.

For example, for a particular object that is detected across the three point cloud frames 132-1-132-3, the object tracker 144 can generate a past trajectory of the particular object that span a time period that begins at the first timestamp t₃ and ends at the third timestamp t₃.

The object tracker 144 can be configured as a Kalman filter model, a key points tracking model, an optical flow model, or another motion estimation model that can track one or more blobs across the point cloud frames included the temporal sequence. A blob refers to a contiguous group of points making up at least a portion an object (i.e., a portion of an object or an entire object), e.g., points contained within a bounding box, or points identified as a point that depicts an object in the point-level segmentation data.

As a particular example, the object tracker 144 can be implemented as a multi-object tracker that can simultaneously track multiple objects from frame to frame by running a Kalman filtering algorithm to track points from an initial frame (e.g., the first point cloud frame 132-1) that depict each of the multiple objects to corresponding points that depict each of the multiple objects in a subsequent frame (e.g., the second point cloud frame 132-2).

The trajectory predictor 145 generates one or more predicted trajectories of each of the one or more detected objects. For a given detected object, the predicted trajectory of the given detected object spans a time period which includes the target timestamp t_{target}. Thus, when the target timestamp t_{target} is a future timestamp that is after the timestamp at which the most recent point cloud frame is received, the predicted trajectory will include data characterizing a predicted future position of the object at the target timestamp t_{target}.

The trajectory predictor 145 can be configured as any suitable motion forecasting model that can process an input that includes the outputs of the object detector 143, the outputs of the object tracker 144, or both and possibly other data to generate an output that specifies one or more predicted trajectories of the given detected object.

For example, the trajectory predictor 145 can be configured as a constant velocity model described in Scott Ettinger, et al. Large scale interactive motion forecasting for autonomous driving: The waymo open motion dataset. In Proceedings of the IEEE/CVF International Conference on Computer Vision, pages 9710-9719, 2021. As another example, the trajectory predictor 145 can be configured as the neural network that can generate a number of predicted trajectories in parallel, as described in Balakrishnan Varadarajan, et al. Multipath++: Efficient information fusion and trajectory aggregation for behavior prediction. In 2022 International Conference on Robotics and Automation (ICRA), pages 7814-7821. IEEE, 2022.

The one or more predicted trajectories of a given detected object can be generated in any appropriate way. For example, the one or more predicted trajectories can be generated deterministically, e.g., by an output of the trajectory predictor 145. In this example, the trajectory predictor 145 can generate, as output, data specifying a fixed set of waypoints that each correspond to a possible position of the object at a respective future timestamp and that make up the one or more predicted trajectories. That is, each waypoint defines a spatial location in the environment that could be traversed by the object, e.g., after the timestamp at which the most recent point cloud frame is received (e.g., after the third timestamp t₃).

As another example, the one or more predicted trajectories can be generated stochastically, e.g., where the output of the trajectory prediction neural network parameterizes a distribution around a possible future trajectory from which each of the one or more predicted trajectories is sampled. In this example, the trajectory predictor 145 can generate, as output, data defining the parameters of a respective probability distribution for each waypoint along a predicted anchor trajectory. From the respective probability distributions, a set of waypoints can be sampled.

As particular example, when configured as the Multipath++ architecture, the trajectory prediction neural network can generate, as output, a respective score for each of a plurality of trajectory modes, and, for each trajectory mode, a probability distribution over possible waypoint locations in the trajectory given that the object follows the mode.

Other ways of generating the predicted trajectories for a given detected object are possible.

The synthetic point cloud generation engine 140 then uses the one or more predicted trajectories that have been generated for each of one or more detected objects to generate the synthetic point cloud frame 146 associated with the target timestamp t_{target}.

The synthetic point cloud frame 146 includes a plurality of synthetic data points that represent the one or more respective predicted locations of each of the one or more detected objects at the target timestamp t_{target}. To that end, each synthetic data point has a position. The position of each synthetic data point can, for example, be represented as either a range and elevation pair, or 3D coordinates (x, y, z), in a coordinate system.

In particular, the positions of the synthetic data points are determined based on the predicted trajectories generated by the trajectory predictor 145. For example, when a predicted trajectory of a given detected object includes data specifying a fixed set of waypoints that make up the predicted trajectory, the synthetic point cloud generation engine 140 can determine the positions of one or more synthetic data points from the spatial locations in the environment defined by a subset of the set of waypoints that each correspond to a possible position of the object at the target timestamp t_{target}.

In some implementations, the synthetic point cloud frame 146 also includes a plurality of synthetic data points that represent one or more respective predicted locations of each of the one or more detected objects at one or more additional timestamps.

For example, when the target timestamp t_{target} is a timestamp after the timestamp at which the most recent point cloud frame is received, each additional timestamp may be a timestamp that is before the target timestamp t_{target} but after the timestamp at which the most recent point cloud frame is received (the third timestamp t₃, in the example of FIG. 1). The positions of these synthetic data points in this example can similarly be determined based on the predicted trajectories generated by the trajectory predictor 145. In this example, the plurality of synthetic data points included in the synthetic point cloud frame 146 will represent, for each of the one or more detected objects, respective predicted locations of the detected object at different future timestamps along one or more predicted trajectories.

In addition to position, each synthetic data point can have other features that are generated based the outputs of the object detector 143, the outputs of the object tracker 144, the outputs of the trajectory predictor 145, or some combination thereof. In some examples, for each synthetic data point, the features include one or more of: a type or category of the object represented by the synthetic data point, a dimension (e.g., width, length, or both) of the object represented by the synthetic data point, an estimated heading (e.g., direction of motion) of the object represented by the synthetic data point, or a confidence score representing a level of confidence of the trajectory predictor that the object represented by the synthetic data point will locate at the predicted location. Other features that can be generated based on information made available in these outputs are possible. For example, those other features can include a binary identifier that indicates whether a data point is real or synthetic.

In some implementations, the synthetic point cloud frame 146 further includes a plurality of laser sensor data points. For example, when the target timestamp t_{target} is a timestamp at which a point cloud frame is received, the synthetic point cloud frame 146 can include (a copy of) the laser sensor data points included in the point cloud frame associated with the target timestamp t_{target} and, optionally, the laser sensor data points included in one or more point cloud frames associated with previous timestamps that precede the target timestamp t_{target}. When included, those laser sensor data points can be represented in, e.g., projected from their respective coordinate systems used in the point cloud frames associated with the previous timestamps into, the same coordinate system as the coordinate system used in the point cloud frame at target timestamp t_{target}.

As another example, when the target timestamp t_{target} is a timestamp after a timestamp at which the most recent point cloud frame is received, the synthetic point cloud frame 146 can include (a copy of) the laser sensor data points included in each point cloud frame in the temporal sequence of point cloud frames (e.g., each of the first, second, third point cloud frames 132-1, 132-2, 132-3, in the example of FIG. 1) that is included in the point cloud data 108 received by the prediction subsystem 112. When included, those laser sensor data points can be similarly represented in the same coordinate system as the coordinate system used in the point cloud frame at target timestamp t_{target}.

The object detection subsystem 130 then provides the generated synthetic point cloud frame 146 associated with the target timestamp t_{target} as input to an object detection neural network 150. The object detection neural network 150 processes the input to generate an object detection output. The object detection output can for example include data that defines a plurality of 3-D bounding boxes with reference to the environment characterized by the synthetic point cloud frame 146 and, for each of the plurality of 3-D bounding boxes, a respective likelihood that an object belonging to an object category from a set of possible object categories is present in the region of the environment circumscribed by the 3-D bounding box.

In some implementations, the object detection neural network 150 can have the same architecture (and have the same or different parameter values) as the object detector 143. For example, both the object detection neural network 150 and the object detector 143 can both be implemented as a neural network having one of the network architectures described in Tianwei Yin, et al. Centerbased 3d object detection and tracking. In Proceedings of the IEEE/CVF Conference on Computer Vision and Pattern Recognition (CVPR), pages 11784-11793, 2021, and Pei Sun, et al. Swformer: Sparse window transformer for 3d object detection in point clouds. In European Conference on Computer Vision. Springer, 2022.

In other implementations, the object detection neural network 150 can have a different architecture than the object detector 143. For example, compared with the object detector 143, the object detection neural network 150 can include one or more additional layers.

Additionally or alternatively, the object detection subsystem 130 can provide the same input that includes the generated synthetic point cloud frame 146 to another neural network included in the prediction subsystem 112.

For example, the other neural network can be a trajectory prediction neural network, which can process the input to generate an output that includes data specifying, for each of one or more objects detected in the input, a predicted future trajectory of the object.

As another example, the other neural network can be a motion state prediction neural network, which can process the input to generate an output that includes data that classifies each of one or more objects detected in the input into a respective motion state, e.g., a dynamic state or a stationary state.

In the example of FIG. 1, the object detection subsystem 130 is implemented on-board the vehicle 102, however it can also be implemented off-board, e.g., hosted in a data center. When implemented off-board, the components of the object detection subsystem 130 may or may not be the same as the those of the object detection subsystem 130 that is implemented on-board the vehicle 102.

For example, the object detection subsystem 130 can be implemented as part of a system that includes or has access to a driving log in a data center. The driving log can be either a real driving log or a simulated one. A real driving log stores sensor data generated from the raw sensor measurements that are continually generated by the sensor subsystem 104 on-board the vehicle 102 as the vehicle (or another vehicle) navigates through real-world environments that includes multiple objects, such as other vehicles. A simulated driving log stores simulated sensor data. Simulated sensor data is generated by a software simulation of the environment. That is, the simulated sensor data simulates sensor data that would be generated by sensors of a vehicle.

In this example, because point cloud frames associated with an arbitrary length of timestamps are included in the already logged sensor data, and are thus available to the system, the object detection subsystem 130 can not only perform “forward” trajectory prediction as described above (where the trajectory predictor 145 process an input that includes data derived from one or more point cloud frames associated with previous timestamps that are before the target timestamp t_{target} to predict possible trajectories of the objects that span future timestamps, including the target timestamp t_{target}), but it can also perform “backward” trajectory prediction.

In backward trajectory prediction, the trajectory predictor 145 can be configured as a reverse motion forecasting model, which can process an input that includes data derived from future point cloud frames associated with future timestamps that are after the target timestamp t_{target} to predict one or more possible trajectories of each of one or more objects that span previous timestamps, including the target timestamp t_{target}. Backward trajectory prediction can be especially helpful when an object will be easily detected within a later, future point cloud frame, but is difficult to detect within previous point cloud frames.

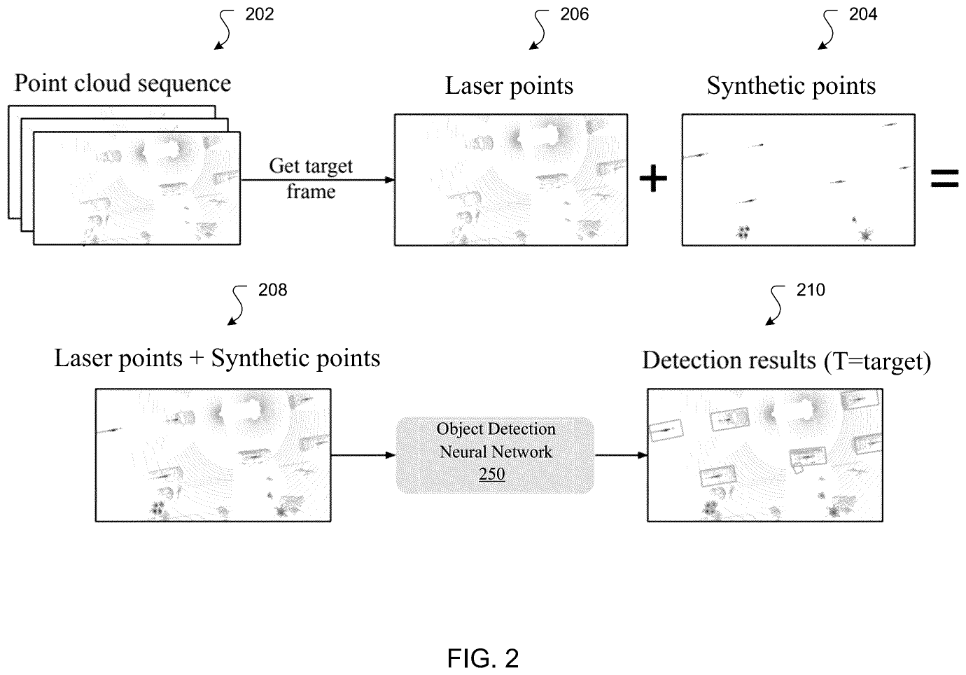

FIG. 2 is an example illustration of operations performed by an object detection subsystem. As illustrated, the object detection subsystem obtains a temporal sequence of multiple point cloud frames 202 associated with different timestamps. The temporal sequence of multiple point cloud frames includes a target point cloud frame associated with a target timestamp and a plurality of other point cloud frames associated with other timestamps.

The object detection subsystem processes one or more other point cloud frames to generate one or more respective predicted locations at the target timestamp for each of one or more objects detected in the one or more other point cloud frames.

The object detection subsystem generates a synthetic point cloud frame 208 that is associated with the target timestamp. The synthetic point cloud frame 208 includes a plurality of synthetic data points 204 and a plurality of laser sensor data points 206. The synthetic data points 204 represent the one or more respective predicted locations of each of one or more objects at the target timestamp. The plurality of laser sensor data points 206 can include the laser sensor data points included in the target point cloud frame associated with the target timestamp.

The object detection subsystem then processes the synthetic point cloud frame 208 using an object detection neural network 250 to generate an output detection output 210. As illustrated, the output detection output 210 includes data that defines a plurality of 3-D bounding boxes with reference to an environment characterized by the synthetic point cloud frame 208.

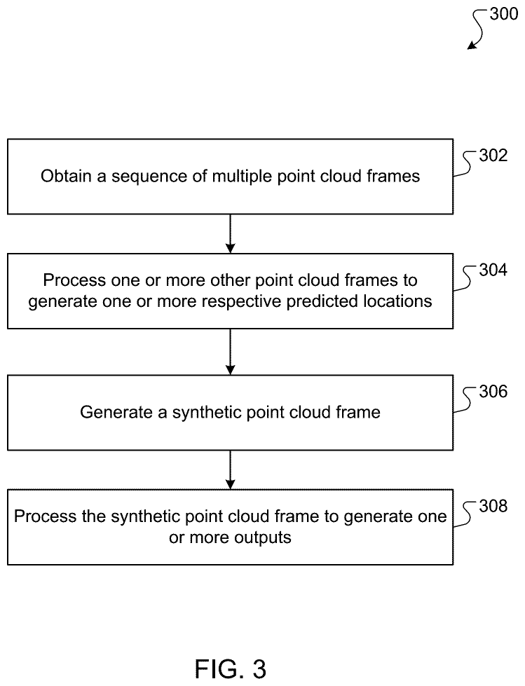

FIG. 3 is a flow diagram of an example process 300 for generating one or more outputs that characterize an environment. For convenience, the process 300 will be described as being performed by a system of one or more computers located in one or more locations. For example, a system, e.g., the on-board system 100 of FIG. 1, appropriately programmed in accordance with this specification, can perform the process 300.

The system obtains a temporal sequence of multiple point cloud frames (step 302). Each point cloud frame in the temporal sequence is associated with a corresponding timestamp and includes a collection of laser sensor data points that are generated from raw laser sensor measurements of a scene in the environment captured by the one or more laser sensors during a specific time window that can be identified by the corresponding timestamp. For example, the one or more laser sensors can include LiDAR sensors of an autonomous vehicle, e.g., a land, air, or sea vehicle, and the scene can be a scene that is in the vicinity of the autonomous vehicle.

Each laser sensor data point in a point cloud frame has a position, and, optionally, other attributes such as intensity, color information, second return, or normals. The position can, for example, be represented as either a range and elevation pair, or 3D coordinates (x, y, z), in a coordinate system that is centered around a position on which the one or more laser sensors are located, e.g., the autonomous vehicle.

In some cases, the temporal sequence of multiple point cloud frames includes a point cloud frame (referred to as a “target point cloud frame”) associated with a target timestamp t_{target}. The target timestamp t_{target} can be any timestamp at which a point cloud frame is received by the system.

For example, the temporal sequence of multiple point cloud frames can include a first point cloud frame associated with a first timestamp t₁, a second point cloud frame associated with a second timestamp t₂, and a third point cloud frame associated with a third timestamp t₃, where the target timestamp t_{target} is one of these three timestamps (e.g., t_{target}=t₁ or t_{target}=t₂ or t_{target}=t₃).

For ease of description, the remaining point cloud frames included in the temporal sequence that are associated with other timestamps will be referred to as “other point cloud frames.” For example, when t_{target}=t₃, the point cloud frames associated with timestamps t₁ and t₂ will be referred as other point cloud frames.

In other cases, the target timestamp t_{target} can be a future timestamp at which a point cloud frame has not yet been received by the system, and thus the temporal sequence of multiple point cloud frames does not include a point cloud frame associated with the target timestamp t_{target}. Continuing with the example above, the target timestamp t_{target} can be any future timestamp that is after the three timestamps (e.g., t_{target}=t₄ or t_{target}=t₅ or t_{target}=t₆). In these other cases, all of the point cloud frames included in the temporal sequence can be referred as other point cloud frames.

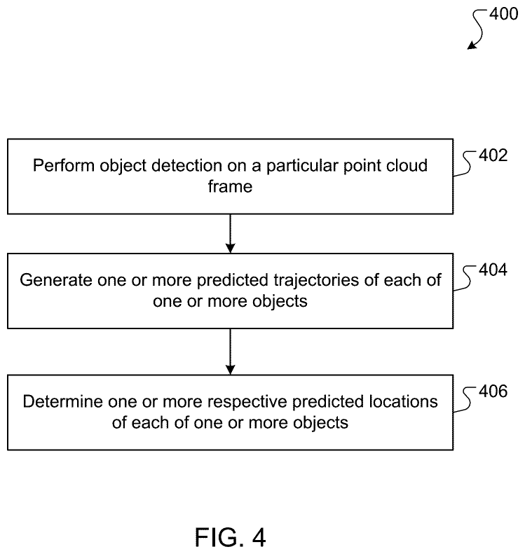

The system processes one or more of the other point cloud frames to generate one or more respective predicted locations at the target timestamp for each of one or more objects detected in the one or more other point cloud frames (step 304). In some implementations, the system can do this by using an object detector, an object tracker, and a trajectory predictor, as explained in more detail with reference to FIG. 4, which shows sub-steps 402-406 corresponding to step 304.

FIG. 4 is a flow diagram of sub-steps of step 304 of the process 300 of FIG. 3.

The system uses the object detector to perform object detection on a particular point cloud frame associated with a particular timestamp of the other timestamps to detect, e.g., identify and locate, one or more objects that are depicted in the particular point cloud frame (step 402).

In general, the particular point cloud frame can be any one of the other point cloud frames, and the step 402 can be repeatedly performed by the system to apply the object detector on each of one or more of the other point cloud frames to detect various objects that are depicted in these other point cloud frames. For example, when t_{target}=t₃, the step 402 can be performed on point cloud frames associated with the first timestamp t₁ and the second timestamp t₂, respectively, to detect one or more objects depicted therein.

The system generates one or more predicted trajectories of each of the one or more objects that span a time period including the target timestamp (step 404). Because the particular timestamp usually precedes the target timestamp t_{target}, the system can do this by first applying the object tracker to generate, for each of one or more objects, a past trajectory that ends before the target timestamp t_{target}.

The object tracker can for example be a motion estimation model, e.g., a Kalman filter model, that tracks the one or more detected objects across the one or more other point cloud frames included in the temporal sequence. To that end, the object tracker can consume the outputs of the object detector, data derived from the outputs of the object detector, or both. For example, when t_{target}=t₃, the system can apply the object tracker to each of one or more of the other point cloud frames, to generate a past trajectory of a particular object that begins from the first timestamp t₁ and ends at the second timestamp t₂, which is before the target timestamp t_{target}.

The system can then apply the trajectory predictor to generate, based on the past trajectory of each of one or more objects, the one or more predicted trajectories of each of one or more objects that span the time period including the target timestamp t_{target}. Each predicted trajectory for an object can for example include a fixed set of waypoints that each correspond to a possible position of the object at a respective future timestamp, e.g., the target timestamp t_{target}, and that make up the predicted trajectory.

The trajectory predictor can for example be a trajectory prediction neural network, such as one that has the Multipath++ architecture mentioned above, that receives an input that includes the outputs of the object detector, the outputs of the object tracker, or both and possibly other data that can be derived from these outputs, and processes the input to generate the one or more predicted trajectories in parallel.

The system determines, from the one or more predicted trajectories of each of the one or more objects, one or more respective predicted locations of the object at the target timestamp t_{target} (step 406). For example, the one or more respective predicted locations of an object can be determined from the spatial locations defined by the waypoints that make up each predicted trajectory along which the object could traverse.

The system generates, based on the respective predicted locations at the target timestamp t_{target} for each of one or more objects, a synthetic point cloud frame that is associated with the target timestamp t_{target} (step 306). The synthetic point cloud frame includes a plurality of synthetic data points that represent the one or more respective predicted locations of each of the one or more objects at the target timestamp t_{target}.

To that end, each synthetic data point has a position that generally indicates a predicted location of an object at the target timestamp t_{target}. Generally, when a predicted trajectory of an object includes data specifying a fixed set of waypoints that make up the predicted trajectory, the system can determine the positions of one or more synthetic data points from the spatial locations in the environment defined by a subset of the set of waypoints that each correspond to a possible position of the object at the target timestamp t_{target}.

For example, after identifying a waypoint corresponding to the object at the target timestamp t_{target}, the system can generate synthetic data points to include in the synthetic point cloud frame based on 1) a spatial location in the environment defined a waypoint and 2) the size and shape of the object (and possibly also other known information about the object, such as the orientation or heading of the object). When there are multiple different possible trajectories generated by the trajectory predictor, the system can select the highest scoring trajectory and use that to generate the synthetic data points, or can alternatively generate respective sets of synthetic data points for multiple ones of the possible trajectories.

Each synthetic data point can also have other features. In some examples, for each synthetic data point, the features include one or more of: a type or category of the object represented by the synthetic data point, a dimension (e.g., width, length, or both) of the object represented by the synthetic data point, an estimated heading (e.g., direction of motion) of the object represented by the synthetic data point, or a confidence score representing a level of confidence of the trajectory predictor that the object represented by the synthetic data point will locate at the predicted location.

In some implementations, the synthetic point cloud frame also includes a plurality of synthetic data points that represent one or more respective predicted locations of each of the one or more detected objects at one or more additional timestamps. For example, the additional timestamps can include the one or more other timestamps included in the temporal sequence.

In some implementations, the synthetic point cloud frame further includes a plurality of laser sensor data points. For example, when the target timestamp t_{target} is a timestamp at which a point cloud frame is received, the synthetic point cloud frame can include (a copy of) the laser sensor data points included in the point cloud frame associated with the target timestamp t_{target} and, optionally, the laser sensor data points included in one or more point cloud frames associated with previous timestamps that precede the target timestamp t_{target}.

The system processes an input that includes the synthetic point cloud frame to generate one or more outputs that characterize an environment at the target timestamp (step 308).

For example, the system can process the input using an object detection neural network to generate an object detection output. The object detection output can include data that specifies, e.g., using 3-D bounding boxes, one or more regions in an environment characterized by the synthetic point cloud frame that are each predicted to depict a respective object.

As another example, the system can process the input using a trajectory prediction neural network to generate a trajectory prediction output. The trajectory prediction output can include data that specifies, for each of one or more objects detected in the input, a predicted future trajectory of the object.

As another example, the system can process the input using a motion state prediction neural network to generate a motion state prediction output. The motion state prediction output can include data that classifies each of one or more objects detected in the input into a respective motion state, e.g., a dynamic state or a stationary state. An example motion state prediction neural network that can be used to generate such a motion state prediction output is described in U.S. Patent Publication No. US20230033989A1.

As yet another example, the system can process the input using a segmentation prediction neural network to generate a segmentation prediction output. The segmentation prediction output can include data which defines, for each data point included in the input, which of multiple object categories the point belongs to. An example segmentation prediction neural network that can be used to generate such a segmentation prediction output is described in U.S. Patent Publication No. US20230281824A1.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
obtaining a sequence of multiple point cloud frames, wherein each point cloud frame includes a respective plurality of laser sensor data points, and wherein the sequence of multiple point cloud frames comprise a target point cloud frame associated with a target timestamp and a plurality of other point cloud frames associated with other timestamps;
processing one or more other point cloud frames to generate one or more respective predicted locations at the target timestamp for each of one or more objects detected in the one or more other point cloud frames;
generating a synthetic point cloud frame that is associated with the target timestamp and that includes (i) a plurality of synthetic data points that represent the one or more respective predicted locations at the target timestamp for each of the one or more objects and (ii) a plurality of laser sensor data points included in the target point cloud frame; and
processing the synthetic point cloud frame to generate one or more outputs that characterize an environment at the target timestamp.

2. The method of claim 1, wherein processing the one or more point cloud frames to generate the one or more respective predicted locations at the target timestamp for each of the one or more objects comprises:
performing object detection on a particular point cloud frame associated with a particular timestamp of the other timestamps to detect one or more objects that are depicted in the particular point cloud frame;
generating one or more predicted trajectories of each of the one or more objects that each span a time period including the target timestamp; and
determining, from the one or more predicted trajectories of each of the one or more objects, one or more respective predicted locations of each of the one or more objects at the target timestamp.

3. The method of claim 2, wherein the particular timestamp precedes the target timestamp, and wherein generating the one or more predicted trajectories of each of one or more objects comprises:
applying an object tracker to generate a past trajectory of each of the one or more objects that ends before the target timestamp; and
generating, based on the past trajectory of each of the one or more objects, the one or more predicted trajectories of each of one or more objects that each span the time period including the target timestamp.

4. The method of claim 2, wherein generating the one or more predicted trajectories comprises generating a plurality of waypoints.

5. The method of claim 3, wherein generating the one or more predicted trajectories comprises:
processing, using a trajectory prediction neural network, an input comprising data derived from the previous trajectory of each of the one or more objects to generate the one or more predicted trajectories in parallel.

6. The method of claim 2, wherein the target timestamp precedes the particular timestamp, and wherein generating the one or more predicted trajectories of the particular object comprises:
generating the one or more predicted trajectories of each of the one or more objects by using a reverse motion forecasting model.

7. The method of claim 1, wherein each synthetic data point has a plurality of features, the plurality of features comprising one or more of:
a type of the object represented by the synthetic data point,
a dimension of the object represented by the synthetic data point,
an estimated heading of the object represented by the synthetic data point, or
a confidence score representing a level of confidence that the object represented by the synthetic data point will locate at the predicted location.

8. The method of claim 1, wherein the one or more outputs comprise one of: an object detection output, a trajectory prediction output, or a motion state prediction output.

9. The method of claim 1, further comprising:
providing the one or more outputs that characterize the environment at the target timestamp to a planning system of a vehicle to generate planning decisions that plan a future trajectory of the vehicle.

10. A system comprising:
one or more computers; and
one or more storage devices storing instructions that, when executed by the one or more computers, cause the one or more computers to perform operations comprising:
obtaining a sequence of multiple point cloud frames, wherein each point cloud frame includes a respective plurality of laser sensor data points, and wherein the sequence of multiple point cloud frames comprise a target point cloud frame associated with a target timestamp and a plurality of other point cloud frames associated with other timestamps;
processing one or more other point cloud frames to generate one or more respective predicted locations at the target timestamp for each of one or more objects detected in the one or more other point cloud frames;
generating a synthetic point cloud frame that is associated with the target timestamp and that includes (i) a plurality of synthetic data points that represent the one or more respective predicted locations at the target timestamp for each of the one or more objects and (ii) a plurality of laser sensor data points included in the target point cloud frame; and
processing the synthetic point cloud frame to generate one or more outputs that characterize an environment at the target timestamp.

11. The system of claim 10, wherein processing the one or more point cloud frames to generate the one or more respective predicted locations at the target timestamp for each of the one or more objects comprises:
performing object detection on a particular point cloud frame associated with a particular timestamp of the other timestamps to detect one or more objects that are depicted in the particular point cloud frame;
generating one or more predicted trajectories of each of the one or more objects that each span a time period including the target timestamp; and
determining, from the one or more predicted trajectories of each of the one or more objects, one or more respective predicted locations of each of the one or more objects at the target timestamp.

12. The system of claim 11, wherein the particular timestamp precedes the target timestamp, and wherein generating the one or more predicted trajectories of each of one or more objects comprises:
applying an object tracker to generate a past trajectory of each of the one or more objects that ends before the target timestamp; and
generating, based on the past trajectory of each of the one or more objects, the one or more predicted trajectories of each of one or more objects that each span the time period including the target timestamp.

13. The system of claim 11, wherein generating the one or more predicted trajectories comprises generating a plurality of waypoints.

14. The system of claim 12, wherein generating the one or more predicted trajectories comprises:
processing, using a trajectory prediction neural network, an input comprising data derived from the previous trajectory of each of the one or more objects to generate the one or more predicted trajectories in parallel.

15. The system of claim 11, wherein the target timestamp precedes the particular timestamp, and wherein generating the one or more predicted trajectories of the particular object comprises:
generating the one or more predicted trajectories of each of the one or more objects by using a reverse motion forecasting model.

16. The system of claim 10, wherein each synthetic data point has a plurality of features, the plurality of features comprising one or more of:
a type of the object represented by the synthetic data point,
a dimension of the object represented by the synthetic data point,
an estimated heading of the object represented by the synthetic data point, or
a confidence score representing a level of confidence that the object represented by the synthetic data point will locate at the predicted location.

17. The system of claim 10, wherein the one or more outputs comprise one of: an object detection output, a trajectory prediction output, or a motion state prediction output.

18. The system of claim 10, wherein the operations further comprise:
providing the one or more outputs that characterize the environment at the target timestamp to a planning system of a vehicle to generate planning decisions that plan a future trajectory of the vehicle.

19. One or more non-transitory computer-readable storage media storing instructions that when executed by one or more computers cause the one or more computers to perform operations comprising:
obtaining a sequence of multiple point cloud frames, wherein each point cloud frame includes a respective plurality of laser sensor data points, and wherein the sequence of multiple point cloud frames comprise a target point cloud frame associated with a target timestamp and a plurality of other point cloud frames associated with other timestamps;
processing one or more other point cloud frames to generate one or more respective predicted locations at the target timestamp for each of one or more objects detected in the one or more other point cloud frames;
generating a synthetic point cloud frame that is associated with the target timestamp and that includes (i) a plurality of synthetic data points that represent the one or more respective predicted locations at the target timestamp for each of the one or more objects and (ii) a plurality of laser sensor data points included in the target point cloud frame; and
processing the synthetic point cloud frame to generate one or more outputs that characterize an environment at the target timestamp.

20. The non-transitory computer-readable storage media of claim 19, wherein processing the one or more point cloud frames to generate the one or more respective predicted locations at the target timestamp for each of the one or more objects comprises:
performing object detection on a particular point cloud frame associated with a particular timestamp of the other timestamps to detect one or more objects that are depicted in the particular point cloud frame;
generating one or more predicted trajectories of each of the one or more objects that each span a time period including the target timestamp; and
determining, from the one or more predicted trajectories of each of the one or more objects, one or more respective predicted locations of each of the one or more objects at the target timestamp.
